(19) United States
(12) Patent Application Publication
(10) Pub. No.: US 2014/0186576 A1
(43) Pub. Date: Jul. 3, 2014

(54) INSULATING MATERIAL CONTAINING NANOCELLULOSE

(71) Applicant: E I DU PONT DE NEMOURS AND COMPANY, Wilmington, DE (US)

(72) Inventors: MARK ANDREW HARMER, Landenberg, PA (US); Ann Y. Liauw, Wilmington, DE (US); Byoung Sam Kang, Midlothian, VA (US); Mark A. Scialdone, West Grove, PA (US)

(73) Assignee: E I DU PONT DE NEMOURS AND COMPANY, Wilmington, DE (US)

(21) Appl. No.: 13/729,130

(22) Filed: Dec. 28, 2012

(51) Int. Cl. H01F 27/32

(52) U.S. Cl. CPC H01F 27/32
USPC 428/116; 428/537.5; 162/157.6; 162/146; 162/205; 162/206

(57) ABSTRACT

A nonwoven web of unmodified or cyanoethylated nanocellulose was found to have greater strength than kraft paper after immersion in oil at high temperature, making it useful as an insulation material for transformers. A mixture of nanocellulose and polymetaphenylene isophthalamide has further improved properties for use as an insulating material.

### FIELD OF THE INVENTION

The present invention relates to nonwoven papers useful for electrical insulation. The nonwoven papers contain unmodified or cyanoethylated nanocellulose, or a composite of the nanocellulose and polymetaphenylene isopthalamide.

### BACKGROUND

Electrical transformers typically have windings of conducting wire which must be separated by a dielectric (i.e. non-conducting) material. Usually the coils and dielectric material are immersed in a fluid dielectric heat transfer medium to insulate the conductor and to dissipate heat generated during operation. The heat-transfer medium, which is typically an oil such as mineral oil or a sufficiently robust vegetable oil, must act as a dielectric as well. The most abundantly used dielectric material has been kraft paper or board, which is made from wood pulp prepared using the kraft chemical process. This process involves treatment of wood chips in a pressure cooker-type digester with a mixture of sodium hydroxide and sodium sulfide solutions. During this process most of the lignin, and additionally hemicellulose, is removed from the cellulose in the wood pulp.

Kraft paper, made from cellulose pulp, has good insulating properties and is economical, but also has lower than desired thermal stability and strength with long term exposure to high temperatures. Various modifications have been made in transformer insulation papers to increase insulation life and functionality, such as reduced hygroscopicity, reduced permittivity, and increased thermal stability. Thermal upgrading of kraft papers was achieved using chemical modifications such as cyanoethylation and use of agents such as dicyandiamide, or a combination of dicyandiamide, melamine, and/or polyacrylamide. Blends of cellulose and various polymers, including aramids (aromatic polyamides) such as Nomex® (DuPont; polymetaphenylene isopthalamide), achieved reduced permittivity and greater thermal stability. Aramid paper, and particularly paper made of Nomex®, has excellent electrical insulation properties as well as strength and toughness, which remains high even at high temperatures. However this paper is costly and is used in specialized transformer insulation that requires more materials with high temperature stability, for example continued use at 200° C. for several months if not years.

Compositions containing nanocellulose, also called microfibrillated cellulose, have been described. Nanocellulose, or microfibril cellulose, has nanometer width dimensions and micrometer length dimensions. These fibers are typically prepared from wood pulp using high-pressure homogenizers, or they may be obtained from certain bacteria. WO2010124868 discloses the production and use of modified microfibrillated cellulose paper for increased paper toughness. The cellulose nanofibrils are modified by coating, formation of charge groups, mechanical beating, or enzymatic degradation.

US20110288194 discloses mixtures of meta-xylylenediamine and a bioresourced reinforcement, that may be a plant fiber, which are injection molded or extruded for use in the automotive industry, construction, sport, and electrical or electronic fields.

A need remains for alternative insulating materials having physical characteristics suitable for long term use in electrical transformers such as an insulating paper that retains more of its strength over time and acts as an effective insulator for an extended time. Similarly, a need exists for an electrical apparatus comprising such insulating material.

### SUMMARY

In one aspect, the present invention provides an insulating material comprising a nonwoven web comprising unmodified nanocellulose or cyanoethylated nanocellulose.

In one embodiment the insulating material further comprises polymetaphenylene isophthalamide.

In other aspects the invention provides a multilayer structure, a honeycomb structure, and a device comprising an electrical conductor and an electrically insulating material such as a transformer, each comprising the insulating material comprising unmodified nanocellulose or cyanoethylated nanocellulose and optionally comprising polymetaphenylene isophthalamide.

A further aspect of the invention provides a process for making a nonwoven insulating paper comprising:
a) forming an aqueous dispersion of unmodified nanocelluolose or cyanoethylated nanocellulose;
b) optionally blending the dispersion of (a) with polymetaphenylene isophthalamide fibrids and optionally polymetaphenylene isophthalamide floc to form a slurry,
c) draining the liquid from the dispersion of (a) or slurry of (b) to yield a wet paper composition, and
d) drying and pressing the wet paper composition to make a formed paper.

The present nonwoven paper is useful as an insulating (dielectric) material in electrical oil-filled transformers. When immersed in oil, a typical fluid dielectric heat transfer medium, the paper retains tensile strength and therefore is an improved insulation paper.

### DETAILED DESCRIPTION OF THE INVENTION

This invention is related to the development of a new nonwoven insulating material for use in electrical applications such as in transformers. The insulating material contains unmodified nanocellulose or nanocellulose that has been modified by cyanoethylation (cyanoethylated nanocellulose) and optionally contains polymetaphenylene isophthalamide

The methods, compositions, and articles described herein are described with reference to the following terms.

As used herein, where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus.

The term “invention” or “present invention” as used herein is a non-limiting term and is not intended to refer to any single embodiment of the particular invention but encompasses all possible embodiments as described in the specification and the claims.

As used herein, the term “about” modifying the quantity of an ingredient or reactant of the invention employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “slurry” refers to a mixture of insoluble material and a liquid.

As used herein, the term “wt %” means weight percent.

As used herein, the term “kraft paper” means a paper made by a kraft pulping process wherein the paper consists of a web of pulp fibers (normally from wood or other vegetable fibers), is usually formed from an aqueous slurry on a wire or screen, and is held together by hydrogen bonding. Kraft paper may also contain a variety of additives and fillers. See, for example, Handbook of Pulping and Papermaking, Christopher Bierman, Academic Press, 1996.

As used herein, the term “nonwoven web” means a manufactured web, paper, or sheet of randomly orientated fibers or filaments positioned to form a planar material without an identifiable pattern. Examples of nonwoven webs include meltblown webs, spunbond webs, carded webs, air-laid webs, wet-laid webs, and spunlaced webs and composite webs comprising more than one nonwoven layer. Nonwoven webs for the processes and articles disclosed herein are desirably prepared using a “direct laydown” process. “Direct laydown” means spinning and collecting individual fibers or plexifilaments directly into a web or sheet without winding filaments on a package or collecting a tow.

The term “fibrids”, as used herein, means a very finely-divided polymer product of fibrous or film-like particles with at least one of their three dimensions being of minor magnitude relative to the largest dimension. Filmy fibrids are essentially two-dimensional particles having a length and width on the order of 10 to 1000 micrometers and a thickness of 0.1 to 1 micrometer. Fibrous shape or stringy fibrids usually have length of up to 2-3 mm, a width of 1 to 50 microns, and a thickness of 0.1 to 1 micrometer. Fibrids are made by streaming a polymer solution into a coagulating bath of liquid that is immiscible with the solvent of the solution. The stream of polymer solution is subjected to strenuous shearing forces and turbulence as the polymer is coagulated.

The term “floc”, also called “flocs” and “flocks”, as used herein, means fibers having a length of 2 to 25 millimeters, preferably 3 to 7 millimeters and a diameter of 3 to 20 micrometers, preferably 5 to 14 micrometers. Floc is typically made by cutting continuous spun filaments into specific-length pieces using well-known methods in the art.

The term “aramid”, as used herein, means a polyamide wherein at least 85% of the amide (—CONH—) linkages are attached directly to two aromatic rings. A meta-aramid is such a polyamide that contains a meta configuration or meta-oriented linkages in the polymer chain.

The term “nanocellulose” as used herein means nano-sized cellulose fibrils. These fibrils have a high aspect ratio (length to width ratio) with width dimensions of less than 1 micrometer, more typically between about 5 and 100 nanometers. Typical length dimensions are 2 or more micrometers. This nanocellulose is also called nanofibrillated or microfibrillated cellulose. Microfibrillated cellulose contains cellulose nanofibrils, also called nanocellulose fibrils.

The term “oil” as used herein refers to any dielectric fluid that includes mineral oil, synthetic hydrocarbons, silicones, ester-containing oil which includes synthetic mono, di or polyol esters as well as natural ester-containing oil, which is typically an oil obtained from plant material (typically seed) called vegetable oil or mixtures thereof. These dielectric fluids may also contain additives that include antioxidants, pour point depressants, metal passivators, and corrosion inhibitors.

The present insulating material is a nonwoven web, also considered to be a paper or board, which contains unmodified nanocellulose or cyanoethylated nanocellulose. The nanocellulose may be any available cellulose fiber preparation that consists of cellulose fibrils which have nanometer width, which is any size less than 1 micrometer. The length of nanocellulose fibrils is typically of micrometer size, thus nanocellulose fibrils have a high aspect ratio (length to width). Microfibrillated cellulose (MFC) is another term for nanocellulose. Nanocellulose is thus distinguished from cellulose by the size of the fibers, which for nanocellulose are called fibrils due to the small dimensions.

Nanocellulose may be prepared from any source of cellulose, such as wood pulp, and is typically achieved using high-pressure homogenizers. The wood pulp is fibrillated to the level of cellulose nanofibrils. Nanocellulose is commercially available from Daicel FineChem Ltd (Osaka, Japan) under the product name Celish. Innventia (Stockholm, Sweden) has also opened a pilot plant for nanocellulose production.

In addition, nanocellulose is produced by some microorganisms, such as bacteria of the genera Acetobacter, Sarcina, and Agrobacterium. Examples of nanocellulose-producing bacteria include Acetobacter xylinum, Acetobacter aceti, Sarcina ventriculi, and Agrobacterium tumefaciens. Preparation of bacterial nanocellulose and films containing bacterial nanocellulose is described in Stevanic et al. (2011) J. of Applied Polymer Science 122:1030-1039). Bacterial nanocellulose typically has width of about 50 nm. Microbial produced nanocellulose may also be used in the present insulating material.

In one embodiment the nanocellulose is cyanoethylated. Cyanoethylation of nanocellulose may be achieved using any method for cyanoethylation of cellulose, such as using methods that are well-known to one skilled in the art. For example, cyanoethylation may be conducted in homogeneous NaOH/urea aqueous solution (Zhou et al. (2010) Polymer Chemistry 1: 1662-1668) or catalyzed by heterogeneous sodium and potassium hydroxide (Sefain et al, (1993) Polymer International 32: 215-255). In one embodiment the nanocellulose is cyanoethylated by reaction with sodium hydroxide, tetramethyl ammonium hydroxide, and acrylonitrile. The degree of substitution by cyanoethylation of the nanocellulose is the average of the number of cyanoethyl groups per cellulose unit, taken over the entire polymer. Each cellulose unit of unsubstituted nanocellulose can be reacted with from 1 to 3 cyanoethyl units. Theoretically the degree of substitution can be on the scale of from about 0 (unsubstituted nanocellulose) to about 1.0 (completely substituted nanocellulose). For the purposes of the present invention, the degree of substitution of the modified (cyanoethylated) polymer is at least about 0.3, and in some embodiments at least about 0.4.

The nanocellulose in the present insulating material has no charged groups added to the nanocellulose fibrils. In addition, the nanocellulose fibrils of the present invention are not coated with a polymer, and are not aggregated into bundles.

In one embodiment the present insulating material additionally includes polymetaphenylene isophthalamide, an aromatic meta-polyamide. Meta-aramid fibers can be spun by dry or wet spinning using any number of processes. U.S. Pat. Nos. 3,063,966; 3,227,793; 3,287,324; 3,414,645; and 5,667,743 are illustrative of useful methods for making aramid fibers that could be used in the practice of the present invention. Meta-aramid polymetaphenylene isophthalamide fibers are commercially available, such as Nomex® aramid fiber available from E. I. du Pont de Nemours and Company (Wilmington, Del.), Teijinconex® aramid fiber available from Teijin Ltd. of (Tokyo, Japan), and Aramet® from Aramid, Ltd. (Hilton Head Island, S.C.).

The use of polymetaphenylene isophthalamide is optional in the practice of the present invention. If included, the polymetaphenylene isophthalamide can be present in an amount of up to about 50 weight % (wt %), relative to the wt % of the combined modified and unmodified nanocellulose.

The polymetaphenylene isophthalamide useful in the practice of the present invention is in the form of fibrids, and optionally can additionally include floc. Preferably, fibrids have a melting point or decomposition point above 320° C. Fibrids are not fibers, but they are fibrous in that they have fiber-like regions connected by webs. Fibrids typically have an aspect ratio in the range of about 5:1 to about 10:1. Fibrids may be used wet in a never-dried state and can be deposited as a binder physically entwined about other ingredients or components of a paper. The fibrids can be prepared by any conventional method including, for example, using a fibridating apparatus of the type disclosed in U.S. Pat. No. 3,018,091 where a polymer solution is precipitated and sheared in a single step. Fibrids can also be made via the processes disclosed in U.S. Pat. No. 2,988,782, U.S. Pat. No. 2,999,788, and U.S. Pat. No. 3,756,908 for example.

The polymetaphenylene isophthalamide floc may be fibers of any length that are useful for preparation of a nonwoven web, but typically the floc fibers have a length in the range of from about 2 to about 25 millimeters, preferably from about 3 to about 7 millimeters, and a diameter in the range of from about 3 to about 20 micrometers, preferably from about 5 to about 14 micrometers. Floc is typically made by cutting continuous spun filaments into specific-length pieces using well-known methods in the art. Examples of floc preparation are described, for example, in: U.S. Pat. No. 3,063,966; U.S. Pat. No. 3,133,138; U.S. Pat. No. 3,767,756; and U.S. Pat. No. 3,869,430.

In one embodiment, polymetaphenylene isophthalamide fibrids are 100% of the polymetaphenylene isophthalamide in the present insulating material. In another embodiment polymetaphenylene isophthalamide floc is also present. In the present invention, the polymetaphenylene isophthalamide consists essentially of either fibrid material or a mixture of fibrid and floc material, so that the amount of floc material that is included can be determined by mass balance. For example, in one embodiment, the polymetaphenylene isophthalamide can be present in an amount of up to 75 weight percent floc, with the remainder (25 to 100 weight percent) being fibrid. In other embodiments, the polymetaphenylene isophthalamide comprises no more than 50 wt % of floc.

One of skill in the art can readily determine the optimal ratio of nanocellulose (cyanoethylated or unmodified) to polymetaphenylene isophthalamide, and of polymetaphenylene isophthalamide fibrids to floc, to be used in the particular manufacturing process to obtain the desired properties, typically with consideration of economic factors such as cost and/or availability.

In addition, in other embodiments conventional additives may be included. Examples of suitable additives include a polymeric binder such as polyvinyl alcohol, polyvinyl acetate, polyamide resin, epoxy resin, phenolic resin, polyurea, polyurethane, melamine formaldehyde, and polyester.

Additional ingredients such as fillers for the adjustment of paper conductivity and other properties, pigments, antioxidants, etc in powder or fibrous form can be added to the insulating material composition of this invention. If desired, an inhibitor can be added to provide resistance to oxidative degradation at elevated temperatures. Preferred inhibitors are oxides, hydroxides and nitrates of bismuth. An especially effective inhibitor is a hydroxide and nitrate of bismuth. One desired method of incorporating such fillers is by first incorporating the fillers into the fibrids during fibrid formation. Other methods of incorporating additional ingredients include adding such components to the slurry during paper forming, spraying the surface of the formed paper with the ingredients and other conventional techniques.

The polymetaphenylene isophthalamide fibrids, and optionally floc, and unmodified or cyanoethylated nanocellulose are combined to form an insulating material that is a dielectric paper with high thermal stability that is a nonwoven web. As employed herein the term paper is employed in its normal meaning and it can be prepared using conventional paper-making processes and equipment. The paper can be formed on equipment of any scale from laboratory filters, screens, or handsheet mold containing a forming screen, to commercial-sized papermaking machinery, such as a Fourdrinier or inclined wire machines. Reference may be made to U.S. Pat. Nos. 3,756,908 and 5,026,456 for processes of forming fibers into papers.

The general process involves making an aqueous dispersion of the fibrids, optional floc, and cyanoethylated nanocellulose, with any optional additional ingredients, blending the dispersion to make a slurry, depositing the slurry on a support, draining the liquid from the slurry to yield a wet composition and drying the wet composition to form a paper. Dispersion of the fibrids, optional floc, and cyanoethylated nanocellulose in aqueous liquid may be made in any order, concurrently, or in separate batches that are mixed.

The aqueous liquid of the dispersion is generally water, but may include various other materials such as pH-adjusting materials, forming aids, surfactants, defoamers and the like. The aqueous liquid is usually drained from the dispersion by conducting the dispersion onto a screen, wire belt, or other perforated support, retaining the dispersed solids and then passing the liquid to yield a wet paper composition. The wet composition, once formed on the support, is usually further dewatered by vacuum or other pressure forces and further dried by evaporating the remaining liquid.

A next step, which can be performed if higher density and strength are desired, is calendering one or more layers of the paper between two heated calendering rolls with the high temperature and pressure from the rolls increasing the bond strength of the paper. Alternatively, one or more layers of the paper can be compressed in a platen press at a pressure, temperature and time, which are optimal for a particular composition and final application. Also, heat-treatment as an independent step before, after or instead of calendaring or compressing, can be conducted if strengthening or some other property modification is desired without or in addition to densification. Calendering also provides the paper with a smooth surface for printing.

The present insulating material was shown herein to have retention of tensile strength which exceeds the tensile strength of kraft paper. Retention of tensile strength may be assessed using an accelerated aging assay where the insulating material is immersed in oil at elevated temperature, as described herein. Oil used in the assay may be any dielectric fluid including mineral oil, synthetic hydrocarbons, silicones, ester-containing oils such as a synthetic mono, di or polyol ester or natural ester-containing oils, the latter of which is typically a vegetable oil. The preferred vegetable oils include high oleic soybean, high oleic sunflower, high oleic canola or olive oil. The oil may include additives, such as anti-oxidants, typically added to increase stability. The elevated temperature of the assay is typically at least about 110° C., and may be at least about 120° C., 130° C., 140° C., 150° C., 160° C., or higher. Retention of tensile strength by the present insulating material exceeds that of kraft paper after treating with any combination of these conditions. In one embodiment, the tensile strength retention at rupture in the machine direction, after at least one week of immersion in oil at a temperature that is at least about 110° C., exceeds that of kraft paper after the same treatment. In another embodiment as shown in Example 6 herein, the tensile strength retention at rupture, after four weeks of immersion in vegetable oil at about 160° C., is at least about two-fold higher than that of kraft paper after the same treatment. In one embodiment the tensile strength is at least about 25 MPa after two weeks of immersion in vegetable oil at about 160° C. The tensile strength after two weeks of immersion in vegetable oil at about 160°C. may be at least about 25, 30, 35, 40, 45, 50, 55, 60, 65, 70, 75, or 80 MPa.

The present insulating material may be a part of a multilayer structure. Other layers in the structure may be any type of insulating material in a paper-type form. Several plies with the same or different compositions can be combined together into the final multilayer structure during forming and/or calendering. For example, a multilayer structure containing layers of insulating papers is disclosed in US 2011/0316660. The present insulating material may be added as a layer in the described structure, or may be used in a structure containing one or more other types of insulating papers. The present insulating material may be an outer and/or an internal layer in a structure of two or more layers. It is preferred that other insulating papers used in the multilayer structure have tensile strength that at least matches the tensile strength of the present insulating material used in the structure, in which case kraft paper would not be included.

In one embodiment, the formed paper has a density of about 0.1 to 0.5 grams per cubic centimeter. In some embodiments the thickness of the formed paper ranges from about 0.002 to 0.015 inches. The thickness of the calendered paper is dependent upon the end use or desired properties and in some embodiments is typically from 0.001 to 0.005 mils (25 to 130 micrometers) thick. In some embodiments, the basis weight of the paper is from 0.5 to 6 ounces per square yard (15 to 200 grams per square meter).

The present paper comprising a nonwoven web as described herein is useful as a component in materials such as printed wiring boards; or where dielectric properties are useful, such as electrical insulating material for use as a wrapping for wires and conductors, and in motors, transformers and other power equipment. The wire or conductor can be totally wrapped, such a spiral overlapping wrapping of the wire or conductor, or can wrap only a part or one or more sides of the conductor as in the case of square conductors. The amount of wrapping is dictated by the application and if desired multiple layers of the paper can be used in the wrapping. In another embodiment, the paper can also be used as a component in structural materials such as core structures or honeycombs. For example, one or more layers of the paper may be used as the primarily material for forming the cells of a honeycomb structure. Alternatively, one or more layers of the paper may be used in the sheets for covering or facing the honeycomb cells or other core materials.

The paper disclosed herein is suitable for use in applications requiring electrical insulating material having the properties of the papers disclosed herein, such as liquid-filled power transformers, distribution transformers, traction transformers, reactors, and their accessory equipment such as switches and tap changers, all of which are fluid-filled. The combination of dielectric fluid and solid insulating paper as described herein provides electrical insulation for an electrical apparatus. In one embodiment, the electrical apparatus comprising the insulating material disclosed herein is an electrical transformer, an electrical capacitor, a fluid-filled transmission line, an electrical power cable, an electrical inductor, or a high voltage switch. In one embodiment, the electrical apparatus is a closed transformer. In one embodiment, the electrical apparatus is an open transformer having a headspace containing an inert gas. In one embodiment, a dielectric material comprises a paper as described herein impregnated with at least 10 weight percent of a dielectric fluid. In one embodiment the transformer is a large scale transformer having the capacity to handle at least 200 kVA, and more generally at least 400 kVA.

The present paper can be used in transformers with dielectric fluids comprising a triglyceride oil, such as vegetable oils, vegetable oil based fluids, and algal oils. Dielectric fluids such as mineral oil, synthetic esters, silicone fluids, and poly alpha olefins may also be used. Examples of vegetable oils include but are not limited to sunflower oil, canola oil, rapeseed oil, corn oil, olive oil, coconut oil, palm oil, high oleic soybean oil, commodity soybean oil, castor oil, and mixtures thereof. Examples of vegetable oil based fluids that can be used are Envirotemp® FR3™ fluid (Cooper Industries, Inc.) and BIOTEMP® Biodegradable Dielectric Insulating Fluid (ABB). Examples of algal oils include but are not limited to those disclosed in published patent application US 2010/0303957. An example of high fire point hydrocarbon oil that can be used is R-Temp® hydrocarbon oil (Cooper Industries, Inc.). Examples of synthetic esters include polyol esters which contain fatty acid moieties of less than about 10 carbon atoms in chain length. Commercially available synthetic esters that can be used include those sold under the trade names Midel® 7131 (The Micanite and Insulators Co., Manchester UK), REOLEC® 138 fluid (FMC, Manchester, UK), and ENVIROTEMP 200 fire-resistant fluid (Cooper Power Fluid Systems). In one embodiment, the dielectric fluid comprises a triglyceride oil. In one embodiment, the triglyceride oil comprises a vegetable oil, a vegetable oil based fluid, an algal oil, or mixtures thereof. In one embodiment, the vegetable oil comprises high oleic soybean oil. Typically, the dielectric fluid has a water content of about 500 ppm or less.

When used as insulating material for a liquid filled transformer, the papers disclosed herein can provide longer term benefit to both the manufacturer and the consumer, since the papers can maintain high tensile strength, and in turn provide extended lifetime for a transformer. Traditional Kraft paper is of lower strength and during the operation of a transformer (which is under both thermal and mechanical stress) can fall appart. This new types of composite give a longer operating lifetime.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations is as follows:

“hr” means hour(s), “min” means minute(s), “sec” means second(s), “d” means day(s), “L” means liter(s), “ml” means milliliter(s), “g” means grams, “g/L” means grams per liter, “mM” means millimolar, “μM” means micromolar, “nm” means nanometer(s), “mm” means millimeters, “cm” means centimeters, “wt %” means weight percent, “MPA” means megapascal(s), “psi” means pounds per square inch, “wt %” means weight percent, “DS” means degree of substitution.

### General Methods

The paper thickness and basis weight (grammage) were determined for papers of this invention in accordance with ASTM D 374 and ASTM D 646 correspondingly. At thickness measurements, method E with pressure on specimen of about 172 kPa was used.

Tensile Strength and Elongation were determined for papers using an Instron-type testing machine in accordance with ASTM D 828-93.

### Example 1

### Preparation of Nanocellulose Based Paper

Nanocellulose was obtained from Daicel FineChem Ltd. (Osaka, Japan) under the product name Celish KY-100G. The typical nanocellulose concentration of the preparations used was about 9.8 wt %. The nanocellulose was initially diluted down to 3 wt % with water. The diluted cellulose was placed in a Waring Blender and blended for about 5 min to give a dispersed 3 wt % nanocellulose containing stock solution. 30 g of the nanocellulose solution was added to 600 ml of water. The mixture was stirred for 10 min. The mixture was then sonicated for 10 min (position 4) using a Heat Systems Ultrasonicator XL2020 (Heat Systems Inc., Farmingdale N.Y.) with the probe about half-way into the solution. The nanocellulose solution was then collected by filtration using a 150 mm diameter Whatman® No. 1, filter paper. The water was removed and the resulting wet paper (damp to the feel) was peeled from the Whatman filter paper, and then placed between two larger pieces of paper (about 8 in×8 in; 20.3 cm×20.3 cm). The paper was pressed at 135° C. and 10000 psi (68.9 MPA) for 20 mins, using a Carver Press. The approximate weight of the paper was about 1 g. For mechanical testing, strips that were about one-half inch wide (1.3 cm) were cut to lengths of 6 inches (15.24 cm) and the tensile strength and elongation to break were measured using an Instron® tensile tset machine (Instron; Norwood, Mass.). The measured tensile strength and elongation were 110 MPa and 5%, respectively.

### Example 2

### Preparation of Nanocellulose Based Paper Using High Temperature

Nanocellulose paper was prepared as described in Example 1 except that the paper was pressed at 150° C. The approximate weight of the paper was about 1 g. For mechanical testing strips that were about one-half inch (1.3 cm) wide were cut and the tensile strength and elongation to break were measured using an Instron. The measured tensile strength and elongation were 118 MPa and 3.33%, respectively.

### Example 3 (Comparative)

### Preparation of Paper Using 100% Kraft Pulp

Transformer paper was produced from cellulosic wood pulp (softwood) from Celco Company (Chile) which was refined to 250 ml of Canadian Standard Freeness, using the method as described in Example (1), except using 150° C. during pressing, and starting with Kraft pulp (0.4 to 0.5 wt %) diluted into 600 mls with water to a concentration of about 0.16 wt %. The approximate weight of the paper was about 1 g. For mechanical testing strips that were about one-half inch (1.3 cm) wide were cut and the tensile strength and elongation to break were measured using an Instron. The measured tensile strength and elongation were 39.76 MPa and 2.55%, respectively.

### Example 4

### Preparation of Cyanoethylated Nanocellulose Paper

Nanocellulose was modified via cyanoethylation using the following method. 9 g of nanocellulose was placed into a 1 liter three neck flask and the total weight was brought up to 400 g with water. 16 g of a 50 wt % sodium hydroxide solution was added with stirring, followed by 0.3 g of tetramethyl ammonium hydroxide pentahydrate. The mixture was stirred (room temperature) and 40 g of acrylonitrile was added dropwise. The mixture was warmed to 50° C. for 60 mins. Then 100 g of isopropanol was added to dissolve any unreacted acrylonitrile. The mixture was allowed to cool to room temperature and the product was neutralized with acetic acid (about 10 ml), then the cyanoethyl cellulose product was filtered and washed with 1000 ml of water. The wet material was then placed in a plastic hag and stored in a refrigerator until required. A small sample of the wet material was dried and the % H, C and N measured using analysis Galbraith Laboritories Chemical Analysis. The % N was then used to determine the degree of substitution (average number of cyanoethylated groups bound per individual glucose monomer) and was found to have a value of about 0.36 (DS), Cyanolethylated nanocellulose paper was prepared as described in Example 1, by replacing nanocellulose with cyanoethylated nanocellulose. The measured tensile strength and elongation were 105 MPa and 4.24% respectively.

### Example 5

### Mixture of Nomex® Fibrid and Cyanoethylated Nanocellulose Paper

A mixture of cyanoethylated nanocellulose and Nomex® fibrid was made by combining 1.35 g of cyanoethylated nanocellulose (prepared as described in Example 4) and 0.15 g of Nomex® fibrid that was prepared as described in U.S. Pat. No. 3,756,908. Paper was made from this mixture using the method as described in Example 2. The measured tensile strength and elongation were 86 MPa and 5.39%, respectively.

### Example 6

### Performance of Nanocellulose Papers in Soy Oil

The Kraft (Example 3), nanocelluloase (Example 1), cyanoethylated nanocellulose (Example 4), and cyanoethylated nanocellulose and Nomex® fibrid (Example 5) papers (1 inch by 1 inch strips; 2.5 cm by 2.5 cm) were immersed in high oleic soy based oil. The oil was prepared from Plenish™ high oleic soybeans (Dupont-Pioneer: Johnston, Iowa). The oil and paper samples were heated at 160° C. for two or 4 weeks. Typically the oil and paper were placed in a glass tube (about 8 in (20.3 cm) long and 2 inch (5.1 cm) diameter and sealed). The stability of the paper was the measured by measuring the tensile strength and elongation as a function of time. The results are shown in Table 1.

TABLE 1
Performance of nanocellulose papers heated in soy oil

| | Time at | Tensile Strength | Elongation |
|---|---|---|---|
| Paper Material | 160° C. in oil | (MPa) | (%) |
| Kraft | 0 | 39.8 | 2.55 |
| Kraft | 2 weeks | 21.66 | 1.12 |
| Kraft | 4 weeks | 20.92 | 1.11 |
| Nanocellulose | 0 | 118 | 3.33 |
| Nanocellulose | 2 weeks | 62 | 1.34 |
| Nanocellulose | 4 weeks | 42 | 2 |
| CE.Nanocellulose | 0 | 105 | 4.24 |
| CE.Nanocellulose | 2 weeks | 111 | 2.65 |
| CE.Nanocellulose | 4 weeks | 84 | 3 |
| Nomex ®/CE/Nanocell | 0 | 86.4 | 5.39 |
| Nomex ®/CE/Nanocell | 2 weeks | 78.3 | 2.74 |
| Nomex ®/CE/Nanocell | 4 weeks | 83 | 3 |

### Example 7

### Paper Prepared with Highly Cyanoethylated Nanocellulose

Nanocellulose was modified via cyanoethylation as in Example 4 except that warming of the mixture was for 90 min rather than 60 min. A small sample of the wet material was dried and analyzed as in Example 4 to measure the % H, C and N. The % N was then used to determine the degree of substitution (average number of cyanoethylated groups bound per individual glucose monomer), which was found to have a value of about 0.47 (DS).

Cyanolethylated nanocellulose paper was prepared as described in Example 1, by replacing nanocellulose with the cyanoethylated cellulose. The measured tensile strength and elongation were 108 MPa and 8.2% respectively. Samples of the highly modified cyanoethyalted papers were aged in oil at 160° C. for 2 or 4 weeks. The measured tensile strength and elongation at 2 weeks were 108 MPa and 4%, respectively, and at 4 weeks were 95 and 2.78%, respectively.

What is claimed is:

1. An insulating material comprising a nonwoven web comprising nanocellulose.

2. An insulating material of claim 1 further comprising polymetaphenylene isophthalamide.

3. The insulating material of claim 1 wherein the material has a tensile strength that is greater than the tensile strength of kraft paper by a factor of at least 25%.

4. The insulating material of claim 1 wherein the material has a tensile strength retention at rupture in the machine direction, after at least one week of immersion in oil at a temperature that is at least about 110° C., which exceeds that of kraft paper after the same treatment.

5. The insulating material of claim 4 wherein the oil comprises oil selected from the group consisting of mineral oil, synthetic hydrocarbons, synthetic mono, di or polyol esters, natural esters and mixtures thereof.

6. The insulating material of claim 4 wherein the tensile strength is at least about 25 MPa after 2 weeks of immersion in high oleic soybean oil at about 160° C.

7. The insulating material of claim 1 comprising cyanoethylated nanocellulose wherein the degree of substitution of the nanocellulose is at least about 0.3.

8. The insulating material of claim 2 wherein the weight percent of polymetaphenylene isophthalamide is 50 or less, relative to the combined weight of the nanocellulose and the polymetaphenylene isophthalamide present in the material.

9. The insulating material of claim 2 wherein from about 25 to about 100 weight percent of the polymetaphenylene isophthalamide is fibrid material.

10. A multilayer structure comprising the insulating material of claim 1 as at least one of the layers.

11. A honeycomb structure comprising the insulating material of claim 1.

12. A device comprising an electrical conductor and an electrically insulating material of claim 1.

13. The device of claim 12 which is a transformer.

14. The transformer of claim 13 which is oil filled.

15. The transformer of claim 13 which has a capacity of at least 200 kVa.

16. The transformer of claim 15 which has a capacity of at least 400 kVA.

17. A process for making a nonwoven insulating paper comprising the steps:
a) forming an aqueous dispersion of nanocellulose;
b) draining the liquid from the dispersion of (a) or slurry of (b) to yield a wet paper composition, and
c) drying and pressing the wet paper composition to make a formed paper.

18. The process of claim 17 wherein the liquid is drained from the slurry using a screen or wire belt.

19. The process of claim 17 further comprising calendering the formed paper with heat and pressure.

20. The process of claim 17 wherein the aqueous dispersion of step (a) is blended with polymetaphenylene isophthalamide to form a slurry prior to the step of draining the liquid.

21. The process of claim 20 wherein the ratio of weight percent of nanocellulose to weight percent of polymetaphenylene isophthalamide is between about 50:50 and 100:0.

22. The process of claim 20 wherein from about 25 to about 100 wt % of the polymetaphenylene isophthalamide is fibrid material.
